(19) United States
(12) Patent Application Publication
(10) Pub. No.: US 2024/0069543 A1
(43) Pub. Date: Feb. 29, 2024

(54) VEHICLE REMOTE GUIDANCE SYSTEM

(71) Applicant: FORD GLOBAL TECHNOLOGIES, LLC, Dearborn, MI (US)

(72) Inventor: Oliver NÖLLE, München (DE)

(21) Appl. No.: 18/455,041

(22) Filed: Aug. 24, 2023

Related U.S. Application Data
(60) Provisional application No. 63/402,531, filed on Aug. 31, 2022.

(51) Int. Cl. G05D 1/00; B60W 40/04; B60W 60/00

(52) U.S. Cl. CPC G05D 1/0022; B60W 40/04; B60W 60/001; B60W 2554/402; B60W 2556/45

(57) ABSTRACT

A vehicle includes a sensor configured to provide sensor data indicative of an environment outside the vehicle; a transceiver configured to communicate with a server; and a controller configured to, responsive to the sensor data indicative of a predefined trigger event, send a request for remote guidance to the server, receive an instruction from the server indicative of a first trajectory having a first priority and a second trajectory having a second priority, and perform a driving maneuver to implement one of the first trajectory or the second trajectory.

### CROSS-REFERENCE TO RELATED APPLICATIONS

This application claims the benefit of U.S. provisional application Ser. No. 63/402,531 filed on Aug. 31, 2022, the disclosure of which is hereby incorporated in its entirety by reference herein.

### TECHNICAL FIELD

The present disclosure generally relates to a system for operating a vehicle. More specifically, the present disclosure relates to a system for performing remote guidance (RG) to an autonomous vehicle.

### BACKGROUND

Some modern vehicles are provided with autonomous driving features which allows the vehicle to be operated autonomously with minimal driver inputs. The autonomous driving features rely on vehicle sensors measuring the driving condition. A controller or processor may be used to process the sensor data indicative of the driving condition to make decisions on how to operate the vehicle. In some situations, the sensor data may reflect a situation that the controller is not ready to process. For instance, if an obstacle is detected (e.g., construction zone) and the vehicle needs to drive onto the oncoming traffic lanes to overcome the obstacle, more sophisticated verifications may be required before the controller is allowed to make such a maneuver.

### SUMMARY

In one or more illustrated examples of the present disclosure, a vehicle includes a sensor configured to provide sensor data indicative of an environment outside the vehicle; a transceiver configured to communicate with a server; and a controller configured to, responsive to the sensor data indicative of a predefined trigger event, send a request for remote guidance to the server, receive an instruction from the server indicative of a first trajectory having a first priority and a second trajectory having a second priority, and perform a driving maneuver to implement one of the first trajectory or the second trajectory.

In one or more illustrated examples of the present disclosure, a method for a vehicle includes responsive to detecting a predefined trigger event via a sensor, stopping the vehicle via a controller and sending data indicative of the trigger event to a server via one or more transceivers; responsive to receiving a response indicative driving instructions to overcome the predefined trigger event from the server via the one or more transceivers, verifying if the vehicle is able to perform the driving instructions via the controller; and responsive to verifying the vehicle is able to perform the driving instructions, operating the vehicle autonomously using the driving instructions via the controller.

In one or more illustrated examples of the present disclosure, a non-transitory computer-readable medium includes instructions, when executed by a controller of a vehicle, cause the vehicle to perform operations including: responsive generating a sensor data indicative of a predefined trigger event, reduce a speed of the vehicle and send the sensor data to a server; responsive to receiving an instruction to overcome the predefined trigger event from the server, verifying if the vehicle is able to perform the instruction; and responsive to verifying the vehicle is able to perform the instruction, operate the vehicle autonomously using the instruction.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 is an example block topology of a vehicle system of one embodiment of the present disclosure.

FIG. 2 is a front-perspective view of an exemplary vehicle with an autonomous driving feature of one embodiment of the present disclosure.

FIG. 3 is an example flow diagram of a process for remote guidance of a vehicle of one embodiment of the present disclosure.

FIGS. 4A and 4B are an example block diagram of the remote guidance system of one embodiment of the present disclosure.

FIG. 5 is an example data framework diagram of the remote guidance system of one embodiment of the present disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things proposes a system for operating an autonomous vehicle. More specifically, the present disclosure proposes a remote guidance system to assist the operation of an autonomous vehicle.

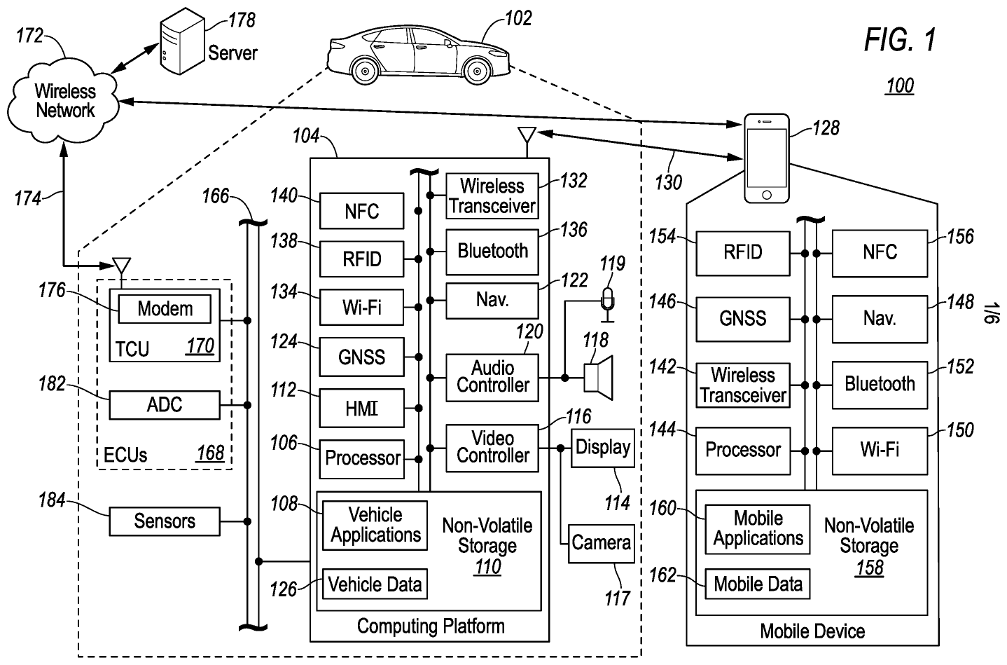

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), a parallel/series hybrid vehicle (PSHEV), or a fuel-cell electric vehicle (FCEV) or other mobile machine for transporting people or goods. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, remote controls, and wireless communications or the like. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and structured query language (SQL).

The computing platform 104 may be provided with various features allowing the vehicle occupants/users to interface with the computing platform 104. For example, the computing platform 104 may receive input from human machine interface (HMI) controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. the computing platform 104 may also drive or otherwise communicate with one or more cameras 117 configured to provide video input to the vehicle 102. The computing platform 104 may also drive or otherwise communicate with one or more speakers 118 configured to provide audio output to vehicle occupants by way of an audio controller 120. The computing platform 104 may also drive or otherwise communicate with one or more microphones 119 configured to provide audio input to the vehicle 102.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, smart fobs, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as a ultra-wide band (UWB) transceiver, a Zigbee transceiver, an IrDA transceiver, and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a GNSS controller 146 and a navigation controller 148. The mobile device 128 may be provided with a wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, UWB, or the like.

The computing platform 104 may be configured to communicate with various electronic control units (ECUs) 168 of the vehicle 102 configured to perform various operations. For instance, the computing platform 104 may be configured to communicate with a telematics control unit (TCU) 170 configured to control telecommunication between vehicle 102 and a wireless network 172 through a wireless connection 174 using a modem 176. The wireless connection 174 may be in the form of various communication network e.g., a cellular network. Through the wireless network 172, the vehicle 102 may access one or more servers 178 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. The ECUs 168 may further include an autonomous driving controller (ADC) 182 configured to control autonomous driving features of the vehicle 102. The vehicle 102 may be further provided with one or more sensors configured to measure various data to facilitate the ACD 182 to perform the autonomous driving operations. As a few non-limiting examples, the sensors 184 may include one or more cameras configured to capture images from the vehicle. The sensors 184 may further include one or more ultra-sonic radar sensors and/or lidar sensors to detect object at the vicinity of the vehicle 102. The sensors 184 may be divided and grouped into one or more sensor assemblies located at different locations of the vehicle 102. In general, the ADC 182 may be configured to autonomously operate the vehicle based on sensor data without requiring inputs or instructions from the server 178. However, in certain situations when the sensor data is indicative of a situation that is difficult for the ADC 182 to make the decision, the vehicle 102 may request further assistance from the server 178 for remote guidance. For instance, responsive to detecting the planned vehicle lane is blocked (e.g., by construction) and overcoming the blockage requires the vehicle 102 to use a lane for oncoming traffic, the ADC 182 may request for remote guidance before proceeding with the maneuver.

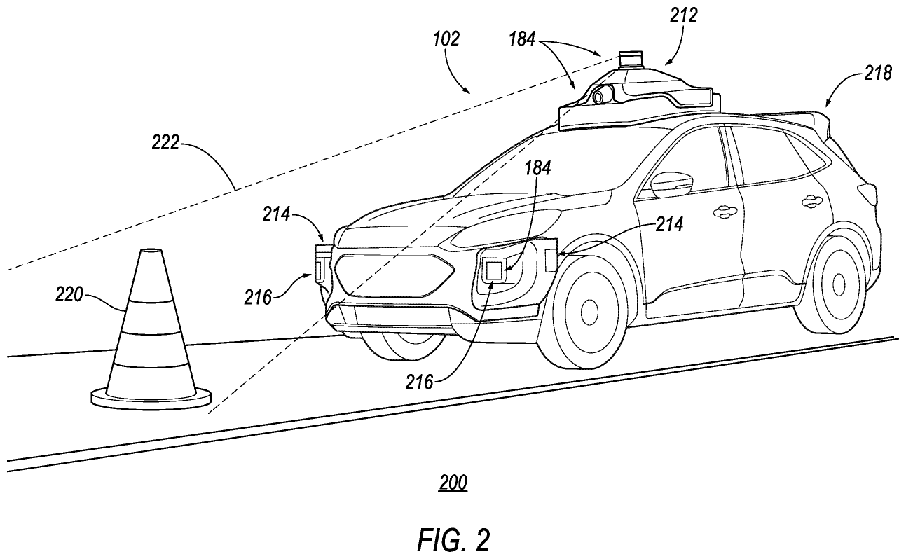

With reference to FIG. 2, a front-perspective view 200 of an exemplary vehicle 102 with an autonomous driving feature of one embodiment of the present disclosure is illustrated. With continuing reference to FIG. 1, the vehicle 102 may include a plurality of sensor assemblies incorporating various sensors 184 to collectively monitor a field-of-view (FoV) around the vehicle 102 in the near-field and the far-field. In the example illustrated with reference to FIG. 2, the vehicle 102 may include a top sensor assembly 212, two side sensor assemblies 214, two front sensor assemblies 216, and a rear sensor assembly 218, according to aspects of the disclosure. Each sensor assembly includes one or more sensors 184, such as a camera, a lidar sensor, and a radar sensor as discussed above with reference to FIG. 1.

The top sensor assembly 212 may be mounted to the top of the vehicle 102 and include multiple sensors 184, such as one or more lidar sensors and cameras. The lidar sensors may rotate about an axis to scan a 360-degree FoV about the vehicle 102. The side sensor assemblies 214 may be mounted to a side of the vehicle 102, for example, to a front fender as shown in FIG. 2, or within a side-view mirror. Each side sensor assembly 214 may include multiple sensors 184, such as, a lidar sensor and a camera to monitor a FoV adjacent to the vehicle 102 in the near-field. The front sensor assemblies 216 may be mounted to a front of the vehicle 102, such as, below the headlights or on the grill. Each front sensor assembly 216 may include multiple sensors 184, for example, a lidar sensor, a radar sensor, and a camera to monitor a FoV in front of the vehicle 102 in the far-field. The rear sensor assembly 218 is mounted to an upper rear portion of the vehicle 102, such as adjacent to a Center High Mount Stop Lamp (CHMSL). The rear sensor assembly 218 may also include multiple sensors 106, such as a camera and a lidar sensor for monitoring the FoV behind the vehicle 104.

As illustrated in FIG. 2, an obstacle 220 (e.g., a construction cone) within a FoV 222 of one or more sensors 184 of the top sensor assembly 212 may be detected. Additionally, the obstacle 220 may also be within a FoV of sensors 184 of other sensor assemblies. Responsive to detecting the obstacle 220, the ADC 182 may process the sensor data and determine an alternative trajectory associated with an evasive maneuver to allow the vehicle 102 to overcome the obstacle. In certain situations, the ADC 182 may determine the alternative trajectory involves minimum complexity and automatically perform the evasive maneuver without seeking for any assistance or approval. In other situations, nevertheless, responsive to determining the alternative trajectory is associated with a complexity higher than a predefined threshold or being unable to determine a practical alternative trajectory, the ADC 182 may slow down and stop before the obstacle 220 and requests for remote guidance from the server 178.

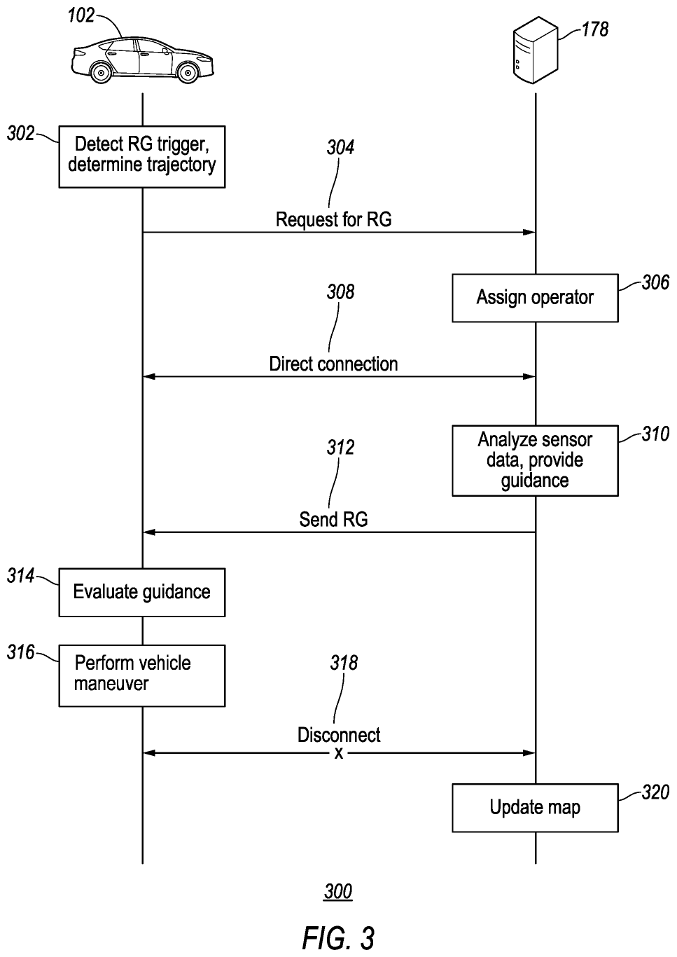

Referring to FIG. 3, an example flow diagram of a process 300 for providing the vehicle remote guidance of one embodiment of the present disclosure is illustrated. With continuing reference to FIGS. 1 and 2, the process 300 may be implemented via the vehicle 102, the server 178 as well as other necessary or optional components shown or not shown. At operation 302, while operating in the autonomous driving mode, the vehicle 102 detects a trigger event that requires the remote guidance from the server 178. The trigger events may include a variety of predefined scenarios beyond the designed capability for the ADC 182 to handle on its own. As a few non-limiting examples, the trigger events may include a blocked lane, active school bus or the like. Details of the trigger events will be discussed below. Additionally, the ADC 182 may be configured to generate one or more alternative trajectories to respond to the trigger event such that vehicle 102 may overcome the detected situation and resume autonomous driving. The alternative trajectories may require further review and approval before the ADC 182 is allowed to perform the evasive maneuvers to implement the alternative trajectories. Alternatively, the remote guidance request may be manually triggered by a vehicle user via the HMI controls 112.

In response to the trigger event, at operation 304, the vehicle 102 communicates to the server 178 to request for remote guidance by sending a request. The remote guidance request may include various information entries. For instance, the remote guidance request may include type/category of the trigger event as detected via vehicle sensors 184. The remote guidance request may further include information associated with the trigger event such as the current location of the vehicle 102, the weather and temperature data. The remote guidance request may further include data reflecting the current condition of the vehicle such as vehicle make/model, suspension setting (e.g., height), fuel level (e.g., battery state of charge), tire pressure, motor/engine operating condition (e.g., temperature), vehicle occupancy data (e.g., number of occupant, presence of children) or the like that may be used to determine if certain maneuvers are available.

In response to receiving the remote guidance request, at operation 306, the server 178 assigns an operator to help provide remote guidance to the requesting vehicle 102. In one example, the operator may be a human being (e.g., technician). Additionally or alternatively, the operator may be a computer program (e.g., artificial intelligence) configured to analyze and resolve more difficult situations than the ADC 182 is configured to handle. For instance, due to the portable nature, the ADC 182 may be configured with relatively limited processing capability and is unable to perform more advanced processing. In comparison, the server 178 may be provided with better processing power and be able to better analyze the sensor data to provide more autonomous driving instructions without the involvement of a human operator. Additionally or alternatively, the server 178 may be further configured to assign different types of trigger events to different levels of operators. For instance, a simple trigger event may be assigned to the computer program, a mid-level trigger event may be assigned to a junior human operator, and a complex trigger event may be assigned to a senor human operator for handling.

Once the remote guidance request has been assigned, at operation 308, the server 178 and the vehicle 102 establish direct connection such that the server 178 is granted access to the various sensor data currently and previously captured via various vehicle sensors 184. For instance, the server 178 may access sensor data indicative of one or more objects within the near-field and/or far-field FoV in one or more directions from the vehicle 102. Due to the large amount of live data to transmit from the vehicle 102 to the server 178, a fast data connection with large bandwidth may be required. In most cases, the direct connection established via the TCU 170 through the wireless network 172 is sufficient for the remote guidance. However, in cases that the direct connection is insufficient to satisfy the data transaction demand, a secondary connection may be established in addition to the direct connection to supplement the data transaction. For instance, the secondary connection may be established via the mobile device 128 associated with a vehicle occupant and connected to the computing platform 104 via the transceiver 132. In response to receiving a request from the computing platform 104 to establish the secondary connection, the mobile device 128 may connect to the server 178 such that the vehicle 102 communicates with the server 178 via both the direct connection and the secondary connection. The computing platform 104 may be further configured to split the sensor data into the two connections based on data importance and/or sensor assemblies. For instance, more important data from the top sensor assembly 212, side sensor assemblies 214, and front sensor assemblies 216 may be communicated to the server 178 via the direct connection, while lesser important data from the rear sensor assembly 218 may be communicated to the server 178 via the secondary connection.

At operation 310, the operator associated with the server 178 analyzes the sensors data and generates input to provide guidance to the vehicle 102. As discussed above, the vehicle 102 may have already generated one or more alternative trajectories for approval. If the operator determines one or more of the alternative trajectories are practical, approvals may be provided to the server 178. Alternatively, the operator may determine and generate one or more new alternative trajectories that are different from the vehicle-generated alternative trajectories as the remote guidance.

At operation 312, the server 178 transmits the remote guidance to the vehicle 102. The remote guidance may include various command entries depending on the specific situations. For instance, the remote guidance may include an approval and/or denial of the one or more vehicle-generated alternative trajectories. The remote guidance may include one or more operator-generated alternative trajectories. In one example, if more than one trajectory is provided, the remote guidance may further include a prioritization of each of the plurality of trajectories. A higher priority may indicate that the associated trajectories are highly recommended whereas a lower priority may indicate that the associated trajectories are lesser recommended.

At operation 314, responsive to receiving the remote guidance, the ADC 182 of the vehicle 102 evaluates the commands indicative of the one or more alternative trajectories. It is noted that although the remote guidance is provided by the server 178, the remote guidance commands are treated more as a recommendation by the ADC 182, rather than mandates. The ADC may further use the priority to prioritize the alternative trajectories if more than one of them are practically implementable. If the ADC 182 determines the commands associated with one or more of alternative trajectories is unavailable or may result in an undesired outcome in a high likelihood, the ADC 182 may refuse to implement the remote guidance commands and seek for alternatives. If none of the alternative trajectories received from the server 178 are practically implementable, the process 300 may repeat operations 304 to 312 until an alternative trajectory is determined and implementable by the ADC 182.

At operation 316, responsive to determining that one or more alternative trajectories are available, the ADC 316 operates the vehicle 102 to perform maneuvers corresponding to the selected alternative trajectory while being monitored by the operator associated with the server 178. The server 178 may continuously send updated trajectories and commands in remote guidance while the vehicle 102 traverses the selected trajectory until the ADC 182 and/or the operator determines the vehicle 102 has successfully overcome the situation associated with the trigger event. At operation 318, the vehicle 102 completes the remote guidance session and disconnect from the server 178.

At operation 320, the server 178 records the trigger event along with the alternative trajectory successfully implemented by the vehicle 102 by updating the map. The updated map may be used to facilitate any future remote guidance request from other vehicles. For instance, responsive to receiving a subsequent remote guidance request from another vehicle associated with the same trigger event, the server 178 may be more likely to assign the current request to a computer program and provide the guidance using the successfully implemented trajectory.

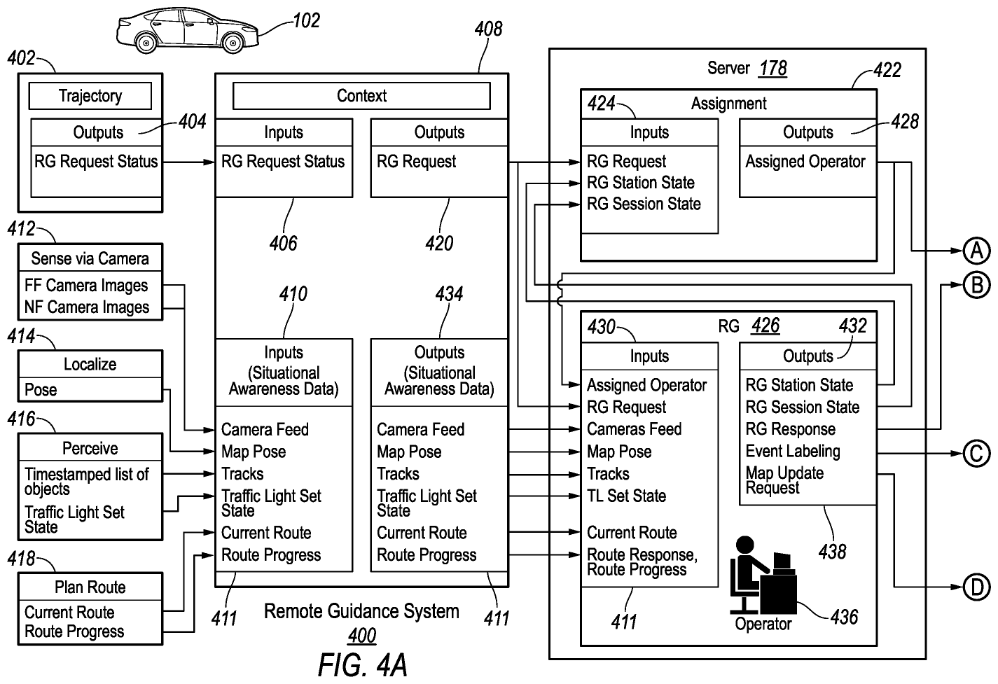

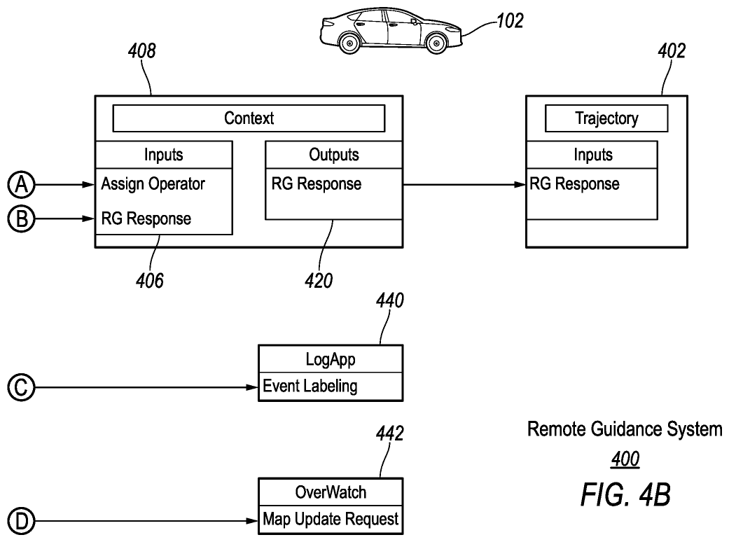

Referring to FIGS. 4A and 4B, an example block diagram of the remote guidance system 400 of one embodiment of the present disclosure is illustrated. With continuing reference to FIGS. 1-3, the remote guidance system 400 includes the vehicle 102 requesting for the remote guidance and the server 178 responding to the remote guidance as the primary components. The vehicle 102 may include various modules/components configured to perform and facilitate the autonomous driving and remote guidance. It is noted that the various modules in the present disclosure may be implemented via computer hardware, and/or computer software as appropriate. For instance, the various modules of the vehicle 102 may be implemented via one or more of the computing platform 104, ECUs 168, sensors 184 or the like in combination with various software programs stored in the storage 110 as vehicle applications 108 or vehicle data 126, or various ECUs 168 as software programs and data.

In the present example, the vehicle 102 may include a trajectory module 402 configured to determine a driving trajectory based on autonomous driving instructions. As discussed above, responsive to detecting a trigger event, the trajectory module 402 may send a remote guidance request via an output interface 404 to a request input interface 406 and a context module 408 configured to facilitate the remote guidance. The context module 408 may be provided with a sensor input interface 410 configured to communicate with various sensors 184 and components to collect situational awareness data 411 associated with the trigger event. For instance, the situation awareness data 411 may include various entries such as camera feed entry indicative of far-field FoV images and near-field FoV images collected from one or more camera modules 412 (e.g., via the camera sensor 184). The situation awareness data 411 may further include a map pose entry indicative of a vehicle position/location and orientation collected from a localize module 414 (e.g., via the GNSS controller 124). The situational awareness data 411 may further include a track entry indicative a timestamped list of objects detected via the one or more sensors 184 and a traffic light set state entry indicative of one or more traffic signal associated with the trigger event collected from a perceiving module 416. The situational awareness data 411 may further include a current route entry indicative of a planned route and a route progress entry indicative of the progress made by the vehicle 102 traversing on the planned route in an autonomous manner collected from a route planning module 418 (e.g., via the navigation controller 122).

The context module 408 may further include a request output interface 420 configured to output the remote guidance request to the server 178. The server 178 may include various modules/components configured to facilitate the remote guidance request. For instance, the server 178 may include an assignment module 422 configured to assign the remote guidance request to an operator. Responsive to receiving the remote guidance request via an assignment input interface 424, the assignment module 422 performs initial evaluation of the request and assigns an operator to handle the request based on the initial evaluation result. The server 178 may further include a remote guidance module 426 configured to process the remote guidance request from the requesting vehicle 102. Responsive to determining an operator suited for the request, the assignment module 422 may communicate with the remote guidance module 426 to verify if the assigned operator is available to handle request in time by sending the assigned operator information to the remote guidance module via an assignment output interface 428. The remote guidance module 426 may include a remote guidance input interface 430 and a remote guidance output interface 432 for communicating with various entities. For instance, in response to receiving the operator assignment via the remote guidance input interface 430, the remote guidance module 426 may communicate a remote guidance station state as well as a remote guidance session state to the assignment module 422 via the remote guidance output interface 426. The remote guidance input interface 430 may be further configured to receive the various situational data 411 entries from a context output interface 434 of the context module 408. An operator 436 that is assigned to the current request may analyze the situational awareness data 411 and provide instructions based on the analysis. As discussed above, the operator 436 may be a computer program integrated with the remote guidance module 426. Additionally or alternatively, the operator 436 may be a human operator interacting with the remote guidance module 426 via an interface.

The remote guidance module 426 may send output data 438 to various entities via the remote guidance output interface 432. For instance, the remote guidance module 426 may output the remote guidance station status entry and the remote guidance session state entry to the assignment module 422 to enable a dynamic operator assignment by the assignment module. For instance, responsive to the data indicative of the assigned operator is unavailable within a predetermined period of time or is incapable of handling the remote guidance request, the assignment module 422 may assign the request to another operator. The remote guidance module 426 may further send a remote guidance response (e.g., instructions) to the context module 408 of requesting vehicle 102. Responsive to receiving the response, the context module 408 may forward the response to the trajectory module 402 to perform the alternative trajectory indicated in the response.

The remote guidance module 426 may further send an event labeling entry to a log application module 440 to record the trigger event and the response for future reference. The remote guidance module 426 may further send a map update request entry to an over watch module 442 to update the map to reflect the trigger event. It is noted that the log application module 440 and the over watch module 442 may be located within the server 178 or outside the server 178.

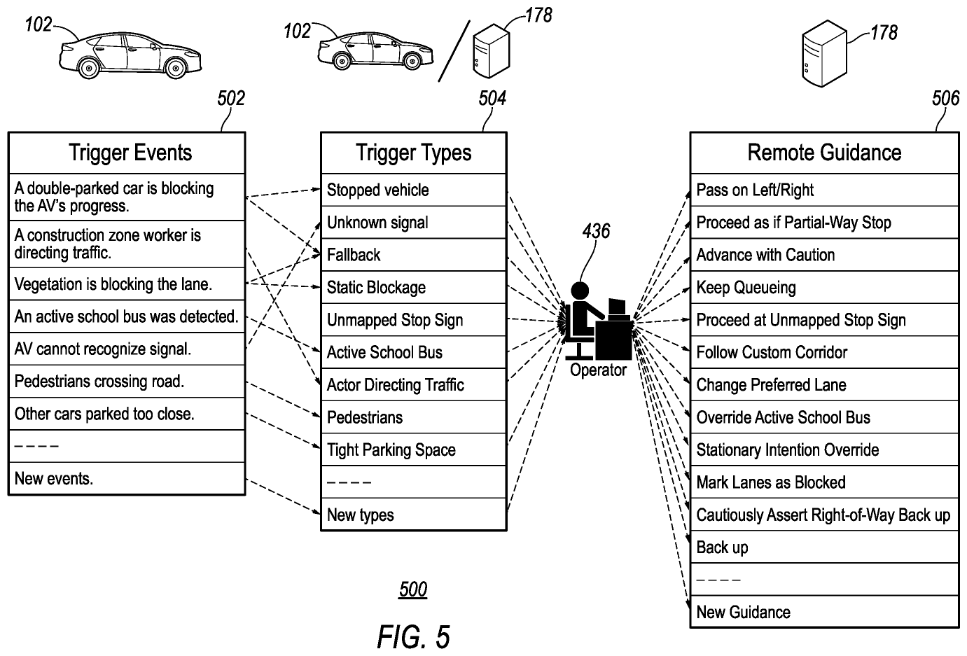

Referring to FIG. 5, an example data framework 500 diagram of one embodiment of the present disclosure is illustrated. With continuing reference to FIGS. 1 to 4, the data diagram illustrates examples of triggers and the corresponding guidance under the remote guidance framework 500. As discussed above, the remote guidance process may start with the requesting vehicle 102 detecting one or more trigger events 502 reflective of various scenarios measured by sensor 184 of the requesting vehicle 102. Each detected trigger event may be classified into one or more of trigger types 504. In the present embodiment, the trigger event classification may be performed by the requesting vehicle 102 or the server 178 under essentially the same concept.

The trigger events 502 may include various scenarios. As a few non-limiting examples, the trigger events 502 may include a double-parked vehicle blocking the requesting vehicle's 102 road scenario which may be processed and classified as stopped vehicle trigger type and/or fallback trigger type. The stopped vehicle trigger type may be applied responsive to the system determining that the requesting vehicle 102 is blocked by a lead vehicle and cannot progress. The fallback trigger type may be applied when the system determines the requesting vehicle 102 is not currently at an intersection and has not moved more than a predefined distance in the past predefined period of time. For instance, if the requesting vehicle 102 stops in traffic and has not been moved over five meters in the past two minutes, the fallback trigger type may be determined. The predefined distance and the predefined period of time may be further dynamically determined using various factors such as traffic, weather, or other data received from the server 178. Alternatively, the fallback trigger type may also apply to scenarios when the requesting vehicle 102 is at an intersection (e.g., waiting for a green light) and has not been moved for more than a predefined period (e.g., four minutes) suggesting an abnormal condition.

The trigger events 502 may further include a “construction zone worker directing traffic” scenario which may be processed and classified as an actor directing traffic trigger type. The actor directing traffic trigger type may be applied responsive to the system determining a human or machine actor directing traffic that is inconsistent with default traffic rules (e.g., a construction worker holding a stop sign at one-lane traffic).

The trigger events 502 may further include a “vegetation blocking the lane” scenario which may be processed and classified as the fallback trigger type and/or a static blockage trigger type. The static blockage trigger type may be applied responsive to the requesting vehicle 102 is blocked by one or more static obstacles such vegetation, construction cones or the like, without any actors directing the traffic.

The trigger events 502 may further include an “active school bus detected” scenario which may be processed and classified as an active school bus trigger type. The active school bus trigger type may be applied responsive to the system detecting a school bus with active signals turned on (e.g., stop sign extended, light flashing).

The trigger events 502 may further include a “signal unable to be recognized” scenario which may be processed and classified as an unknown signal trigger type. The unknown signal trigger type may be applied responsive to the system detecting that the requesting vehicle 102 cannot proceed due to an unrecognized traffic light state such as conflicting signals or signs (e.g., red light and green light at the same time, no left turn and left turn allowed signs at the same time, or the like)

The trigger events 502 may further include a “pedestrians continue to cross the road” scenario which may be processed and classified as a high-density pedestrians trigger type. The local area may be known to have high pedestrian density by the system. The requesting vehicle 102 may have stopped for a predefined period of time (e.g., thirty seconds) as the road is blocked by a high density of pedestrian continuing to cross the road or occupy the road against the traffic rules making it almost impossible for the requesting vehicle 102 to proceed in the near future. The high-density pedestrians trigger type may be applied to such scenarios.

The trigger events 502 may further include a “cars parking too close” scenario which may be processed and classified as a tight parking space trigger type. The tight parking space trigger may be applied when the parked requesting vehicle 102 detects one or more adjacent vehicles parked too close making it difficult to maneuver out of the parking space. For instance, when the requesting vehicle 102 is parallel parked on the side of a road and a preceding vehicle is parked too close to the front bumper, the requesting vehicle 102 may be unable to exit the parking space without first reversing to make more frontal room.

Additionally, the requesting vehicle 102 may further detect one or more scenarios that does not correspond to any predefined scenarios or trigger types. In this case, the system may collectively classify the scenarios as new trigger types. In some situations, sensors 184 of the requesting vehicle 102 may be unable to obtain sufficient perception to analyze and classify the scenario into one of the predetermined trigger types. The new trigger types may be used in these situations to start the remote guidance. As the situation plays out during the remote guidance, the requesting vehicle 102 and/or the operator 436 may perceive more information of the trigger scenario and therefore classify the scenario accordingly.

Once one or more trigger types 504 are assigned to the trigger event, an operator 436 may be assigned to handle the remoted guidance request. As discussed above, the assignment may be performed by each of the trigger types. For instance, a first operator may be assigned to handle requests classified as stopped vehicle and fallback trigger types, a second operator may be assigned to handle unknown signal types, and a third operator may be assigned to handle new trigger types. Regardless of the specific trigger types, the operator 436 may provide the corresponding remote guidance 506 in response to the trigger events 502.

The remote guidance 506 may include various commands. For instance, the remote guidance 506 may include a pass on left/right command to instruct the requesting vehicle 102 to go around and pass the obstacle from either the left or right lane from the originally planned lane. For instance, the pass on left/right command may grant permission to the vehicle to pass the obstacle within a predefined distance (e.g., fifty meters) ahead on the specified side which the operator deems appropriate. The pass on left/right command may be used to respond to various trigger types. As a few non-limiting examples, the pass on left/right command may be used in response to the stopped vehicle, fallback, and/or static blockage trigger types when appropriate. For instance, responsive to detecting a vehicle parallel parked on a driving lane, the requesting vehicle 102 may pass the vehicle on the left/right as instructed by the operator 436.

The remote guidance 506 may further include a “proceed as if partial-way stop” command to instruct the requesting vehicle 102 to proceed when there are no predicted conflicts with other actors while any cross-traffic may be assumed to have the right-of-way. Responsive to receiving the “proceed as if partial-way stop” command, the requesting vehicle may cautiously proceed when no predicted conflicts are predicted or detected. However, responsive to predicting or detecting any upcoming or current conflicts by other members of the traffic which is assumed to have the right-of-way, the requesting vehicle 102 will yield until the conflicts are cleared. The “proceed as if partial-way stop” command may be used to respond to various trigger types. As a few non-limiting examples, the “proceed as if partial-way stop” command may be used in response to the unmapped stop sign trigger type, and/or unknown signal when appropriate. For instance, responsive to detecting an unknown signal state (e.g., red light and green light flashing at the same time), the requesting vehicle 102 may proceed slowly and yield to any cross-traffic that is assumed to have the right-of-way.

The remote guidance 506 may further include an “advance with caution” command to instruct the requesting vehicle to proceed with caution. Driving limitations will be imposed in this situation. For instance, the “advance with caution” command may be associated with a speed limit (e.g., 5 mph) and/or a reduced front distance buffer (e.g., reduced from 20 cm to 10 cm) while allowing the requesting vehicle 102 to proceed (e.g., shallow water). The “advance with caution” command may be used to respond to various trigger types. As a few non-limiting examples, the “advance with caution” command may be used in response to the stopped vehicle, and/or unknown signal trigger types when appropriate. For instance, responsive to detecting a vehicle is stopped in an adjacent lane, the requesting vehicle 102 may advance with caution while being prepared to stop until completely passed the stopped vehicle.

The remote guidance 506 may further include a “keep queuing” command to instruct the requesting vehicle 102 to continue to wait in the line. A time limit may be imposed with the “keep queuing” command. For instance, responsive to receiving the “keep queuing” command, the requesting vehicle 102 may be prohibited from requesting for another remote guidance for a period of time (e.g., 15 seconds). The “keep queuing” command may be used to respond to various trigger types. As a few non-limiting examples, the “keep queuing” command may be used in response to the stopped vehicle, and/or active school bus trigger types. For instance, responsive to detecting the stopped leading vehicle is caused by traffic ahead of it, the requesting vehicle 102 may be instructed to keep queuing in the traffic.

The remote guidance 506 may further include a “proceed at unmapped stop sign” command to authorize the requesting vehicle 102 to proceed past an unmapped stop sign which the requesting vehicle 102 will not pass by default (e.g., at an intersection). Responsive to receiving the proceed at “unmapped stop sign” command, the requesting vehicle 102 monitors other members of the traffic and proceeds to pass the unmapped stop sign once the ADC 182 determines it is appropriate to do so.

The remote guidance 506 may further include a “follow custom corridor” command which defines a customized corridor including one or more waypoints specified by the operator. Responsive to receiving the “follow custom corridor” command, the requesting vehicle 102 may navigate the trajectory using the waypoints rather than the mapped/painted lane marks. The “follow custom corridor” command may be used to respond to various trigger types. As a few non-limiting examples, the “follow custom corridor” command may be used in response to the stopped vehicle, fallback, and/or static blockage trigger types. For instance, responsive to detecting a fallen tree blocking the road, the operator 436 may define a customized corridor around the fallen tree to all the requesting vehicle 102 to pass.

The remote guidance 506 may further include a “change preferred lane” command to instruct the requesting vehicle to merge into a new preferred lane. The requesting vehicle 102 is not forced to change to the new preferred lane but will do so once there is an appropriate opportunity. The requesting vehicle 102 may remain in the new preferred lane until the guidance ends or operator issues a new command. For instance, responsive to detecting that the traffic is building up ahead in the current lane of the requesting vehicle 102, the operator may issue the “change preferred lane” command to the vehicle.

The remote guidance 506 may further include an “override active school bus” command to instruct the requesting vehicle 102 to treat the detected school bus as inactive and allowing the requesting vehicle 102 to pass with caution. For instance, sometimes an inactive school bus (e.g., not pickup or dropping off passengers) parked off the road may be misidentified as active. Responsive to determining that the flashing lights from the bus does not require stopping/yielding, or a bus driver indication to pass (e.g., waving gesture at the requesting vehicle), the operator may determine the school bus to be inactive and issue the “override active school bus” command.

The remote guidance 506 may further include a “stationary intention override” command to indicate that one or more member the traffic as detected by the requesting vehicle 102 is intended to remain stopped until the member starts to move at which point the command is automatically overridden.

The remote guidance 506 may further include a “marked lanes as blocked” command to instruct the requesting the vehicle 102 to recalculate the route taking into account the marked lanes are impassable. The “marked lanes as blocked” command may be used to respond to various trigger types. As a few non-limiting examples, the “marked lanes as blocked” command may be used in response to the fallback, and/or static blockage trigger types.

The remote guidance 506 may further include a “cautiously assert right-of-way” command to instruct the requesting vehicle 102 to proceed at a low speed. The “cautiously assert right-of-way” command may be used to respond to various trigger types. As a few non-limiting examples, the “cautiously assert right-of-way” command may be used in response to the high-density pedestrians, and/or actor directing traffic trigger types. For instance, in response to the high-density pedestrian trigger, the “cautiously assert right-of-way” command may instruct the requesting vehicle 102 to slowly approach the crowd and activate lights (e.g., flashing head lights, turning on blinker lights) in an effort to urge the crowd of pedestrians to yield to the requesting vehicle 102.

The remote guidance 506 may further include a “backup” command to instruct the requesting vehicle 102 to perform a backup maneuver. The “backup” command may be used to respond to various trigger types. As a few non-limiting examples, the “backup” command may be used in response to the tight parking space, and/or static blockage trigger types. For instance, in response to a tight parking space trigger indicative of the requesting vehicle 102 being parked too close to a front vehicle, the “backup” command may instruct the requesting vehicle 102 to perform a backup/reverse maneuver until there is sufficient room to allow the requesting vehicle 102 to exit from a parallel parking space.

Additionally, the remote guidance 506 may further include any new commands which are not a part of any pre-existing commands in response to the new trigger events and new trigger types.

Additionally, the operator 436 may further analyze the trigger scenarios and provide feedback with regard to the trigger types to which the scenarios are classified in an effort to make the classification better. For instance, the requesting vehicle 102 and/or the server 178 may misclassify certain trigger scenarios to one or more wrong trigger types. Responsive to receiving the operator feedback indicative of the correct trigger types, the vehicle 102 and/or server 178 may take the feedback into account to facilitate any future classifications.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a sensor configured to provide sensor data indicative of an environment outside the vehicle;
a transceiver configured to communicate with a server; and
a controller configured to,
responsive to the sensor data indicative of a predefined trigger event, send a request for remote guidance to the server,
receive an instruction from the server indicative of a first trajectory having a first priority and a second trajectory having a second priority, and
perform a driving maneuver to implement one of the first trajectory or the second trajectory.

2. The vehicle of claim 1, wherein the controller is further configured to:
responsive to verifying the first trajectory is unavailable and the second trajectory is available, perform the driving maneuver to implement the second trajectory.

3. The vehicle of claim 1, wherein the controller is further configured to:
responsive to verifying both the first trajectory and the second trajectory are available, perform the driving maneuver to implement the first trajectory, wherein the first priority is higher than the second priority.

4. The vehicle of claim 1, wherein the controller is further configured to:
analyze the sensor data to determine a trigger type; and
send the trigger type to the server.

5. The vehicle of claim 1, wherein the predefined trigger event is indicative of a presence of a school bus in a vicinity of the vehicle, and the instruction further includes a command to not proceed in response to a determination that the school bus is active.

6. The vehicle of claim 1, wherein the predefined trigger event is indicative of a presence of a plurality of pedestrians within a vehicle route, and the instruction further includes proceeding toward the pedestrians below a predetermined speed.

7. The vehicle of claim 1, wherein the predefined trigger event is indicative of an obstacle blocking a vehicle route, and the first trajectory is indicative of a first alternative route passing the obstacle on a first side, and the second trajectory is indicative of a second alternative route passing the obstacle on a second side opposite to the first side.

8. The vehicle of claim 1, wherein the predefined trigger event is indicative of an unrecognized signal on a vehicle route, and the instruction further includes proceeding toward the unrecognized signal and yield to other traffic presumed to have a right-of-way.

9. The vehicle of claim 1, wherein the predefined trigger event is indicative of an actor directing traffic conflicting with default traffic rules, and the instruction further includes proceeding toward the actor below a predetermined speed.

10. A method for a vehicle, comprising:
responsive to detecting a predefined trigger event via a sensor, stopping the vehicle via a controller and sending data indicative of the trigger event to a server via one or more transceivers;
responsive to receiving a response indicative driving instructions to overcome the predefined trigger event from the server via the one or more transceivers, verifying if the vehicle is able to perform the driving instructions via the controller; and
responsive to verifying the vehicle is able to perform the driving instructions, operating the vehicle autonomously using the driving instructions via the controller.

11. The method of claim 10, wherein the response is further indicative of a first trajectory having a higher priority and a second trajectory having a lower priority, the method further comprising:
responsive to verifying the first trajectory is available, performing the driving instructions to implement the first trajectory via the controller; and
responsive to verifying the second trajectory is unavailable, performing the driving instructions to implement the second trajectory via the controller.

12. The method of claim 10, further comprising:
responsive to detecting the predefined trigger event via the sensor, generating an alternative trajectory via the controller, and sending the alternative trajectory to the server via the one or more transceivers; and
responsive to receiving the response indicative of an approval of the alternative trajectory, implementing the alternative trajectory via the controller.

13. The method of claim 10, further comprising:
establishing a first wireless connection with a mobile device via the one or more transceivers;
sending a first sensor data to the server via the first wireless connection through the mobile device; and
sending a second sensor data to the server via a second wireless connection without going through the mobile device.

14. The method of claim 10, wherein the predefined trigger event is indicative of a presence of a school bus in a vicinity of the vehicle, and the driving instructions include a command to not proceed in response to a determination that the school bus is active.

15. The method of claim 10, wherein the predefined trigger event is indicative of a automobile parked before the vehicle within a predefined threshold, and the driving instructions include a command to reverse the vehicle.

16. A non-transitory computer-readable medium comprising instructions, when executed by a controller of a vehicle, cause the vehicle to perform operations comprising:
responsive generating a sensor data indicative of a predefined trigger event, reduce a speed of the vehicle and send the sensor data to a server;
responsive to receiving an instruction to overcome the predefined trigger event from the server, verifying if the vehicle is able to perform the instruction; and
responsive to verifying the vehicle is able to perform the instruction, operate the vehicle autonomously using the instruction.

17. The non-transitory computer-readable medium of claim 16, further comprising instructions, when executed by a controller of a vehicle, cause the vehicle to perform operations comprising:
generate an alternative trajectory, and send the alternative trajectory to the server; and
responsive to receiving the instruction indicative of an approval of the alternative trajectory, implementing the alternative trajectory.

18. The non-transitory computer-readable medium of claim 16, further comprising instructions, when executed by a controller of a vehicle, cause the vehicle to perform operations comprising:
responsive to receiving a request for an additional sensor data from the server, send the additional sensor data to the server.

19. The non-transitory computer-readable medium of claim 18, further comprising instructions, when executed by a controller of a vehicle, cause the vehicle to perform operations comprising:
responsive to receiving the instruction indicative of a first trajectory having a first priority and a second trajectory having a second priority, verifying an availability of the first trajectory and second trajectory using sensor data; and
responsive to verifying one of the first trajectory and the second trajectory is available and another is unavailable, implement the one that is available regardless of the priority.

20. The non-transitory computer-readable medium of claim 16, wherein the predefined trigger event is indicative of a parked automobile blocking a vehicle route, and the instruction is indicative of keep waiting behind the parked automobile.
